(19) United States
(12) Patent Application Publication
(10) Pub. No.: US 2013/0337335 A1
(43) Pub. Date: Dec. 19, 2013

(54) NEGATIVE ELECTRODE MATERIAL FOR A SECONDARY BATTERY AND METHOD FOR MANUFACTURING SAME

(71) Applicants: Won-Bae Kim, Gwangju (KR); Jong-Guk Kim, Gwangju (KR)

(72) Inventors: Won-Bae Kim, Gwangju (KR); Jong-Guk Kim, Gwangju (KR)

(73) Assignee: Gwangju Institute of Science and Techology

(21) Appl. No.: 14/001,436

(22) PCT Filed: Dec. 15, 2011
(86) PCT No.: PCT/KR2011/009655

§ 371 Date: Aug. 23, 2013

(30) Foreign Application Priority Data
Feb. 25, 2011 (KR) 1020110017452

(51) Int. Cl. H01M 4/36; H01M 4/04; H01M 4/583

(52) U.S. Cl. CPC H01M 4/366; H01M 4/583; H01M 4/0402; H01M 4/0471; B82Y 30/00
USPC 429/231.8; 427/113; 977/762; 977/784

(57) ABSTRACT

The present invention relates to a negative electrode material for a secondary battery and to a method for manufacturing same. The negative electrode material includes a graphite matrix and a plurality of tin-oxide nanorods disposed on the graphite matrix. Thus, when the negative electrode material is used as the negative electrode for a secondary battery, the negative electrode material may provide high initial capacity (1010 mAhg⁻¹) and coulombic efficiency, superior rate capability, and improved electrochemical properties. Further, the method for manufacturing the negative electrode material for a secondary battery includes: a step of activating a surface of graphite; coating tin-oxide nanoparticles onto the activated surface of the graphite so as to form tin-oxide seed-type graphite; and heating the tin-oxide seed-type graphite using heated water in order to grow a plurality of tin-oxide nanorods.

### TECHNICAL FIELD

The present invention relates to a negative electrode material for a secondary battery and a method for manufacturing same, and more particularly, to a carbon based negative electrode material including a plurality of tin oxide nanorods formed on the graphite matrix to have improved Coulombic efficiency and high-rate capability, and a method for preparing the same capable of simply and easily controlling diameters and lengths of the tin oxide nanorods grown on the graphite matrix by a catalyst-assisted hydrothermal process.

### BACKGROUND ART

Various kinds of metal oxides such as Co₃O₄, CuO, NiO, Fe₃O₄, SnO₂, and the like, have been widely developed as an alternative electrode material of a lithium ion battery (LIB) due to high energy density and relatively low cost. Particularly, SnO₂ based materials have a theoretical capacity (about 781 mAhg⁻¹) about two times higher than a theoretical lithium storage capacity of graphite (about 372 mAhg⁻¹) and advantages such as low cost, stability, and the like, such that the SnO₂ based materials have been significantly spotlighted as a prominent alternative material replacing a currently commercialized graphite anode.

However, it is still difficult to actually implement an electrode using the SnO₂ based material. The reason is that during a charging and discharging process, significant volume expansion of about 250% may occur, which may cause a problem in cyclability.

One way to solve this problem is to prepare the SnO₂ based electrode material so as to have a nanostructure. More specifically, the SnO₂ nanostructure may have a 1-dimensional structure such as a nanowire, a nanotube, and a nanorod. A technology of obtaining a higher lithium storage capacity of about 1134 mAhg⁻¹ in an initial cycle and a lower capacity fading of 1.45% per cycle by synthesizing 1-dimensional SnO₂ nanowires as described above has been disclosed [Park M. S. et al., Angew. Chem. Int. Ed., 2007, 119, 764-767].

In addition, a technology for 1-dimensional SnO₂ nanorods having stable capacity retention in a relatively low electric potential window and a high initial capacity of 1100 mAhg⁻¹ has been disclosed [Wang Y., Lee J. Y., J. Phys. Chem., B2004, 108, 17832-17837].

However, in the case of using the nanomaterials in these technologies as an electrode, there was a problem such as coagulation between the nanomaterials. In addition, there was a problem in that Coulombic efficiency and energy density were decreased by irreversible side reactions generated due to a large surface area of the nanomaterials.

In order to solve these problems, a technology of synthesizing a complex so that SnO₂ nanoparticles are uniformly dispersed in a buffering matrix has been developed. Since carbon based materials used as the buffering matrix have high electric conductivity, excellent mechanical properties, and a reversible capacity retention property, SnO₂ complexes containing the carbon based material have various advantages. In this sense, a SnO₂-graphite complex containing SnO₂ nanoparticles fixed onto a graphite surface to have more excellent capacity retention as compared to pure SnO₂ nanomaterials has been announced [Wang Y., Lee J. Y., J. Power Sources 2005, 144, 220-225].

Even though complex may prevent a coagulation phenomenon, there were problems in that an amount of loaded SnO₂ was significantly affected by an area of the graphite surface or dispersity of the nanoparticles.

### DISCLOSURE

### Technical Problem

An object of the present invention is to provide a negative electrode material for a secondary battery including a graphite matrix and a plurality of tin oxide nanorods formed on the graphite matrix to have a large storage capacity, high Coulombic efficiency and cycle stability, and high-rate capability.

Another object of the present invention is to provide a method for preparing a negative electrode material for a secondary battery capable of simply and easily controlling diameters and lengths of the tin oxide nanorods grown on the graphite matrix according to the use by a hydrothermal process.

### Technical Solution

In one general aspect, there is provided a negative electrode material for a secondary battery including: a graphite matrix; and a plurality of tin-oxide nanorods formed on the graphite matrix.

In another general aspect, there is provided a method for preparing a negative electrode material for a secondary battery, the method including: activating a graphite surface; coating tin oxide nanoparticles onto the activated graphite surface to prepare a tin oxide seed-type graphite; and hydrothermally heating the tin oxide seed-type graphite to grow a plurality of tin oxide nanorods.

### Advantageous Effects

The negative electrode material for a secondary battery according to the present invention may have improved Coulombic efficiency, excellent high-rate capability, and cycle stability.

In addition, the method for preparing a negative electrode material for a secondary battery according to the present invention may simply and easily control diameters or lengths of tin oxide nanorods grown on a graphite matrix by a catalyst assisted hydrothermal process.

### DESCRIPTION OF DRAWINGS

FIGS. 1 to 3 are process diagrams showing a method for preparing a negative electrode material for a secondary battery according to the present invention;

FIG. 4 is a scanning electron microscope (SEM) image of pure graphite prepared in Example of the present invention;

FIG. 5 is a high-resolution transmission electron microscopy (HRTEM) image of tin oxide seed-type graphite prepared in an Example of the present invention;

FIG. 6 is a SEM image of a negative electrode material for a secondary battery prepared in the Example of the present invention;

FIG. 7 is SEM images of tin oxide nanorods grown on the graphite according to the concentration of [Sn(OH)₆]² and reaction time;

FIG. 8 is a graph showing x-ray diffraction (XRD) patterns of the negative electrode material for a secondary battery prepared in the Example of the present invention;

FIGS. 9 and 10 are TEM and HRTEM images of the tin oxide nanorods prepared in the Example of the present invention;

FIG. 11 is a thermogravimetric analysis (TGA) curve of the negative electrode material for a secondary battery prepared in the Example of the present invention;

FIG. 12 is a graph showing a current versus an electric potential of a tin oxide nanowire as a Comparative Example;

FIG. 13 is a graph showing a current versus an electric potential of the negative electrode material for a secondary battery prepared in the Example of the present invention;

FIG. 14 is a voltage profile of the negative electrode material for a secondary battery prepared in the Example of the present invention;

FIG. 15 is a graph showing a capacity versus the number of cycles of the negative electrode material for a secondary battery prepared in the Example of the present invention;

FIG. 16 is a diagram showing a capacity fading ratio and Coulombic efficiency versus the length of the nanorod of the negative electrode material for a secondary battery prepared in the Example of the present invention;

FIG. 17 is a diagram showing a relationship between a tin oxide content and a one-time discharge capacity according to the length of the nanorod of the negative electrode material for a secondary battery prepared in the Example of the present invention;

FIG. 18 is a graph showing capacities of the tin oxide nanowires and nanoparticles versus the number of cycles in various current densities as the Comparative Examples;

FIG. 19 is a graph showing capacities of a plurality of negative electrode materials for a secondary battery prepared in the Example of the present invention according to the number of cycles in various current densities;

FIG. 20 is a graph showing Nyquist plots of tin oxide nanowires and nanoparticles as the Comparative Examples; and

FIG. 21 is a graph showing Nyquist plots of a plurality of the negative electrode materials for a secondary battery prepared in the Example of the present invention.

### BEST MODE

The present invention may be variously modified and have various types, and exemplary embodiments of the present invention will be described in detail with reference to the accompanying drawing. However, the present invention is not limited to the exemplary embodiments described herein, but all of the modifications, equivalents, and substitutions within the spirit and scope of the present invention are also included in the present invention. In describing each of the drawing, similar components will be denoted by similar reference numerals.

Unless otherwise defined herein, technical and scientific terms used in the present specification have the same meanings as those understood by specialists in the skilled art to which the present invention pertains. Generally used terms as defined in a dictionary should be construed as meanings equal to contextual meanings in the related art and not construed as ideal or excessively formal meanings as long as the meanings are not clearly defined in the present specification.

Hereinafter, exemplary embodiments of the present invention will be described in detail with reference to the accompanying drawings.

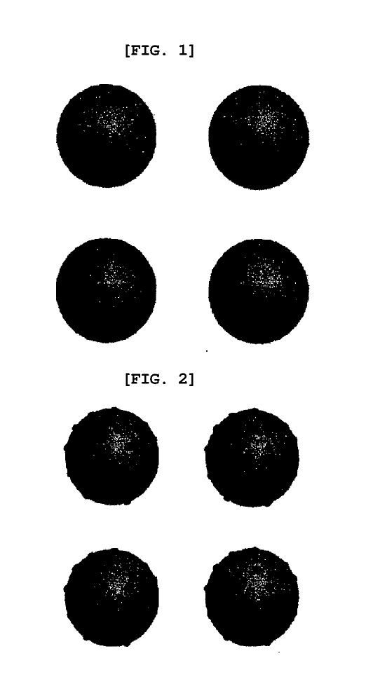

FIGS. 1 to 3 are process diagrams showing a method for preparing a negative electrode material for a secondary battery according to the present invention.

Referring to FIG. 1, since a surface of mainly used graphite powder is in an inactivated state, in order to coat a SnO₂ seed layer to be described below and grow nanorods, first, the graphite surface needs to be activated. In order to activate the graphite surface, a method of refluxing graphite in a mixed acid containing nitric acid (HNO₃) and sulfuric acid (H₂SO₄), or nitric acid (HNO₃) and hydrochloric acid (HCl) may be used. After activating the graphite surface, in order to remove impurities capable of remaining in the graphite powder, it is preferable that the graphite powder may be sufficiently washed with a large amount of distilled water.

Referring to FIG. 2, the tin oxide seed-type graphite may be prepared by coating tin oxide nanoparticles onto the activated graphite surface. At this time, after the activated graphite powder is dispersed in a solution in which a hydrate of a material containing tin is contained, a solution containing hydroxyl ions is added to the dispersion solution and then stirred. As an example, the hydrate of the material containing tin may be tin (II) chloride pentahydrate (SnCl₄.5H₂O), and the solution containing the hydroxyl ions may be a sodium hydroxide (NaOH) aqueous solution. In the case in which the dispersion solution is prepared by dispersing activated graphite powder in the solution containing tin (II) chloride pentahydrate and the sodium hydroxide aqueous solution is added thereto, precipitated tin oxide (SnO₂) nanoparticles are generated. Thereafter, the SnO₂ nanoparticles are coated on the graphite surface through a stirring and heat treating process. As described above, the SnO₂ nanoparticles may be seeded on the activated graphite surface by hydrolysis of the tin (II) chloride pentahydrate. In this case, a molar ratio of sodium hydroxide (NaOH) to tin (II) chloride pentahydrate (SnCl₄.5H₂O) may be preferably 1:10.5 to 1:24.

Referring to FIG. 3, the tin oxide seed-type graphite is hydrothermally heated, thereby grow a plurality of SnO₂ nanorods.

Growth of the SnO₂ nanorods is generated according to the following reactions.

Sn⁴⁺+4OH⁻→Sn(OH)₄ (1)

Sn(OH)₄+2OH⁻→[Sn(OH)₆]²⁻ (2)

[Sn(OH)₆]²⁻→SnO₂+2H₂O+2OH⁻ (3)

Sn(OH)₄ prepared by the reaction according to Formula (1) is decomposed by excessive OH⁻ anions to form a compound ([Sn(OH)₆]²⁻) of Formula (2). The compound ([Sn(OH)₆]²⁻) is converted into SnO₂ by a hydrothermal process according to Formula (3).

In this case, it is preferable that square pillar shaped SnO₂ nanorods having a rectangular cross-section are obtained. To this end, a concentration of [Sn(OH)₆]²⁻ and a molar ratio of SnCl₄.5H₂O to NaOH may be controlled. The concentration of [Sn(OH)₆]²⁻ for growing the SnO₂ nanorods is preferably higher than 0.05M. In the case in which the concentration of [Sn(OH)₆]²⁻ is lower than 0.1M, for example, in the case in which the concentration is 0.05M, the SnO₂ nanorods are not formed until 24 hours elapse, but the SnO₂ nanorods are formed after a longer time (48 hours) elapses.

As described above, the plurality of SnO₂ nanorods may be vertically grown from the graphite surface by the hydrothermal process in the [Sn(OH)₆]²⁻ aqueous solution and the shapes, the diameters, and the lengths of the SnO₂ nanorods may be easily controlled, respectively, while changing the concentration of the [Sn(OH)₆]²⁻ aqueous solution and the reaction time.

Meanwhile, the negative electrode material for a secondary battery according to the present invention contains a graphite matrix and a plurality of tin oxide nanorods formed on the graphite matrix. The graphite matrix may be a plurality of graphite cores, and each of the plurality of tin oxide nanorods may have a square pillar shape and a rectangular cross-section. In this case, the plurality of tin oxide nanorods formed on the plurality of graphite cores may be disposed so as to enclose the graphite core. A content of tin oxide may be preferably 50 to 90% by weight based on the total weight of the graphite matrix.

In addition, an average diameter of the plurality of tin oxide nanorods may be in a range of 28 to 84 nm, and an average length thereof may be in a range of 123 to 646 nm.

For example, in the case of applying the negative electrode material for a secondary battery to a lithium ion battery, during a charging process, that is, while Li⁺ ions are inserted, the Li⁺ ions may easily move into a spaced space between the grown nanorods to penetrate through each of the SnO₂ nanorods, and the SnO₂ nanorods may provide a relatively short diffusion length of the Li⁺ ions due to its structural characteristics.

In addition, since the graphite matrix has high electric conductivity, electrons may be effectively transferred by allowing the electrons to easily move through the 1-dimensional SnO₂ nanorods. The plurality of SnO₂ nanorods are spaced apart from each other by a predetermined distance to thereby be individually grown on the graphite matrix, such that electrolyte permeability for more rapidly moving the Li⁺ ions may be increased. In addition, since the plurality of SnO₂ nanorods are firmly transplanted on the graphite surface to thereby be bonded thereto, breakdown of the SnO₂ nanorods from the graphite may be prevented.

Movement of the electrons may be improved due to high electric conductivity of the graphite, and the SnO₂ nanorods may serve as a buffer section moving mechanical stress during the charging/discharging process due to its high flexibility. Further, the negative electrode material for a secondary battery according to the present invention may increase Coulombic efficiency due to a decrease in unnecessary side reactions related to electrolysis on the graphite surface, as compared to a pure SnO₂ electrode. Therefore, the negative electrode material for a secondary battery according to the present invention may have a significant influence on improving performance of the lithium ion battery.

Hereinafter, in order to assist in understanding of the present invention, preferable Example is described. However, the following Example is only for assisting in the understanding of the present invention, but the present invention is not limited thereto.

### Example

### 1. Activation of Graphite Surface

Graphite powder having an average diameter of 20 μm was stirred in an acidic solution in which HNO₃ (70%, Aldrich) and HCl (30%, Aldrich) were mixed at a ratio of 1:3 (v/v) for 12 hours to activate a graphite surface. Then, the graphite powder was washed with distilled water (18.2MΩ cm) and dried by a vacuum freeze drying method.

### 2. Preparation of SnO₂ Seed-Type Graphite

SnO₂ was seeded on the activated graphite surface by simple hydrolysis of SnCl₄ using NaOH. To this end, first, 0.5 g of the activated graphite powder was dispersed in 4.1 mL of 0.054M SnCl₄.5H₂O (98%, Aldrich) aqueous solution. Then, 4.1 mL of 0.106M NaOH (99.99%, Aldrich) aqueous solution was added thereto while strongly stirring the solution. Precipitated colloidal SnO₂ nanoparticles were formed by the above-mentioned processes. Subsequently, after magnetic stirring for 12 hours, SnO₂ seed-type graphite powder was washed with distilled water and ethanol several times and then dried in a convection oven at 70° C. Then, the dried powder was heat treated at 400° C. under Ar atmosphere for 2 hours.

### 3. Growth of SnO₂ Nanorods on SnO₂ Seed-Type Graphite

0.075 mol NaOH (99.99%, Aldrich) was mixed in 50 mL of 0.1M SnCl₄.5H₂O (98%, Aldrich) aqueous solution, and a tin precursor solution was injected into an Teflon inlet of an autoclave. The tin precursor solution was magnetically stirred for 20 minutes under air atmosphere to prepare a transparent and uniform precursor solution.

Meanwhile, after 0.1 g of the SnO₂ seed-type graphite prepared above was added to the precursor solution, the mixture was hydrothermally heated at 200° C., and the temperature was maintained for 24 to 72 hours. A material obtained by the above-mentioned processes was washed with distilled water and ethanol and dried in a convection oven in which a temperature was maintained at 70° C.

In addition, SnO₂ nanorods having various sizes were synthesized by changing the concentration of the solutions using 50 mL of 0.2M SnCl₄.5H₂O aqueous solution and 0.105 mol NaOH.

TABLE 1
Average diameter and length of nanorods according to the
concentration of [Sn(OH)₆]²⁻ and reaction time

| | Sample | Sample | Sample | Sample | Sample | Sample |
|---|---|---|---|---|---|---|
| | (S) 1 | (S) 2 | (S) 3 | (S) 4 | (S) 5 | (S) 6 |
| Diameter | 28 | 34 | 37 | 62 | 80 | 84 |
| (d) (nm) | | | | | | |
| Length | 123 | 271 | 352 | 409 | 571 | 646 |
| (L) (nm) | | | | | | |

The average diameter and length of the SnO₂ nanorods (S1 to S3) formed on the graphite by mixing 0.075 mol NaOH in 50 mL of 0.1M SnCl₄.5H₂O (98%, Aldrich) aqueous solution were 28 to 37 nm and 123 to 352 nm according to a growth time, respectively. Meanwhile, in the case of mixing 50 mL of 0.105 mol NaOH in 50 mL of 0.2M SnCl₄.5H₂O (98%, Aldrich) aqueous solution, the average diameter and length of the SnO₂ nanorods (S4 to S6) were 62 to 84 nm and 409 to 646 nm, respectively.

In addition, SnO₂ nanowires and nanoparticles were separately synthesized for comparison with other nanostructures. The SnO₂ nanowires were synthesized using an Au catalyst in a vapor-liquid-solid growth mechanism using chemical vapor deposition (CVD). In this case, the synthesized SnO₂ nanowire had a diameter of about 80 nm and a length of micrometer (μm). Further, the SnO₂ nanoparticles having a diameter of about 100 nm were synthesized by a hydrothermal process of 50 mL of 0.01M SnCl₄.5H₂O aqueous solution containing 6.7 mol NaOH at 200° C. for 24 hours.

Measurement was performed using JEOL JSM-7500F as a scanning electron microscope (SEM). XRD patterns of powder samples were recorded with a diffractometer (Rigaku Rotalflex RU-200B) using a Cu Kα (λ=1.5418 ∪) source having a Ni filter at 40 kV, 40 mA, and a scanning rate of 0.02° s⁻¹. Observation was performed using a transmission electron microscope (TEM) and a high resolution transmission electron microscope (HRTEM, JEOL JEM-2100) operated at 200 kV. A content (wt. %) of SnO₂ was investigated by thermogravimetric analysis at a heating rate of 10° C. mim⁻¹ under air atmosphere.

In addition, slurry obtained by mixing the graphite containing the SnO₂ nanorods grown thereon, carbon black, carboxymethyl cellulose, and styrene butadiene rubber with one another at a weight ratio of 80:10:5:5 was pasted on a pure copper foil using a doctor blade method to prepare an electrode, and then dried in a vacuum oven at 145° C. for 3 hours. The resultant was used as a working electrode. Meanwhile, 1M LiPF₆ in which ethylene carbonate and diethyl carbonate were mixed at a volume ratio of 1:1 was used as the electrolyte, and a pure lithium foil was used as a counter electrode. Further, Celgard 2400 was used as a separator. These materials were assembled in a glove box in which humidity and a concentration of oxygen were maintained lower than 1 ppm and Ar was filled, to thereby completing a cell of a 2-electrode system.

Thereafter, cyclic voltammetry (CVs) was performed in a range of 2.5 to 0.01V at a scanning rate of 0.05 mVs⁻¹ using AMETEK Solartron analytical 1400. In addition, the manufactured cells were cycled at 0.01 to 1.5V and 72 mAg⁻¹ in a constant current system using WBCS 3000 battery tester. After the initial cycle, measurement results of electrochemical impedance spectroscopy (EIS) using a multi-impedance test system were recorded. The frequency range was 100 kHz to 10 mHz with AC amplitude of 5 mV.

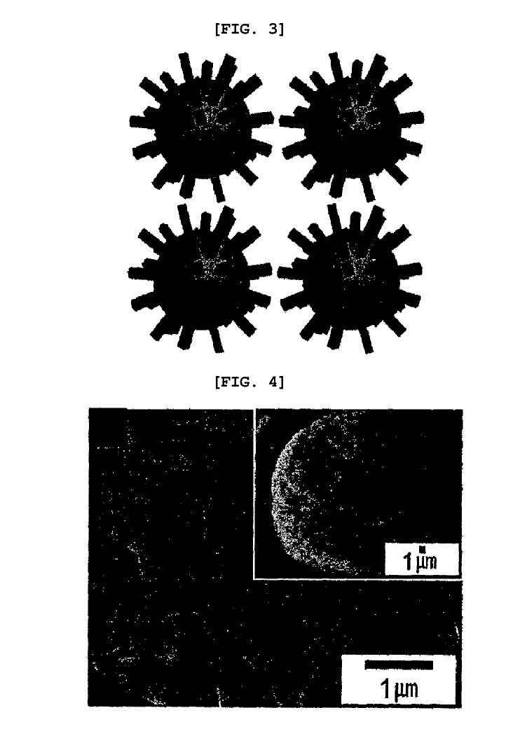

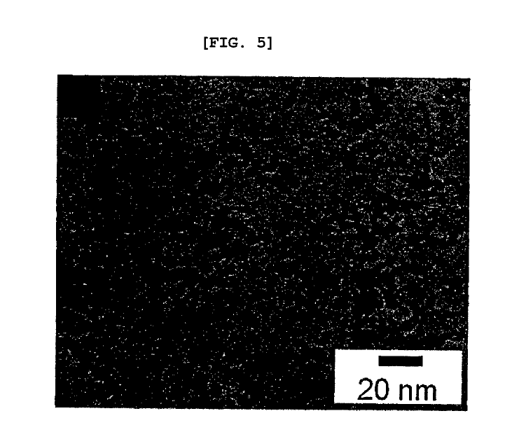

FIG. 4 is a scanning electron microscope (SEM) image of pure graphite prepared in the Example of the present invention.

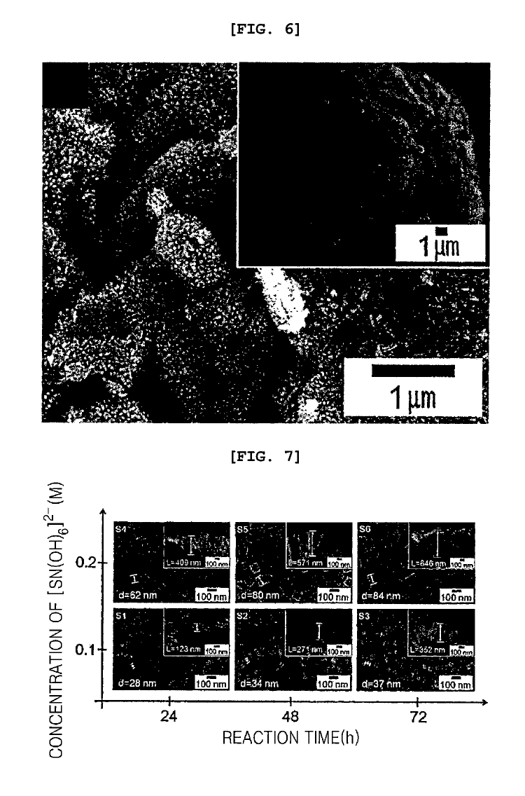

FIG. 5 is a high-resolution transmission electron microscopy (HRTEM) image of the tin oxide seed-type graphite prepared in the Example of the present invention.

FIG. 6 is a SEM image of a negative electrode material for a secondary battery prepared in the Example of the present invention.

Referring to FIGS. 4 to 6, it may be confirmed through the Examples of the present invention that the SnO₂ nanoparticles were uniformly dispersed on the pure graphite surface and closely adhered to the graphite by heat-treatment. Since the SnO₂ nanoparticles coated onto the graphite surface served as a seed to thereby allow the SnO₂ nanorods to be grown, coating of the SnO₂ seed layer played an important role in growth of the SnO₂ nanorods.

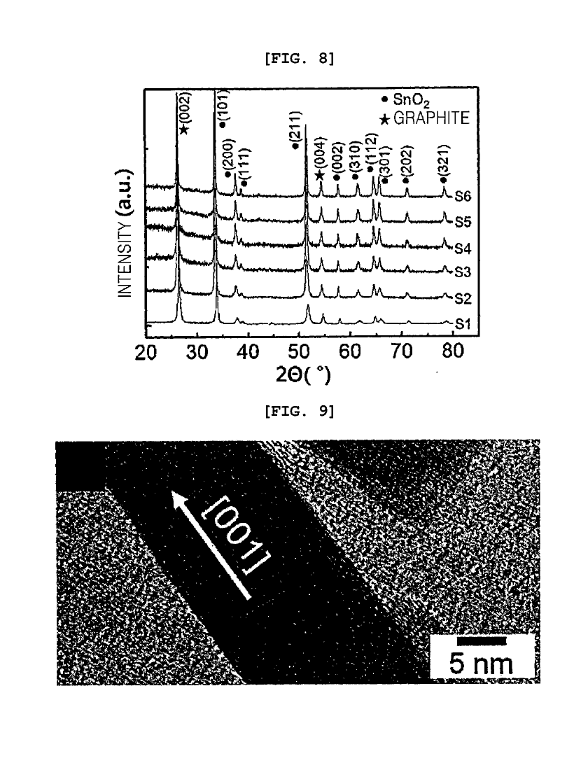

FIG. 7 is SEM images of tin oxide nanorods grown on the graphite according to the concentration of [Sn(OH)₆]² and reaction time.

Referring to FIG. 7, it may be confirmed that the SnO₂ nanorod is a square pillar having a rectangular cross-section and densely distributed on the entire graphite surface. Each of the samples (S1 to S6) was prepared under specific synthesis conditions, and it may be confirmed that the average diameter and length of the prepared SnO₂ nanorods may be controlled to 28 to 84 nm and 123 to 646 nm, respectively. Further, it may be confirmed through the results as described above that as the concentration of [Sn(OH)₆]²⁻ and the reaction time were increased, the diameter and length of each nanorod were increased.

FIG. 8 is a graph showing x-ray diffraction (XRD) patterns of the negative electrode material for a secondary battery prepared in Example of the present invention.

Referring to FIG. 8, it may be confirmed through the XRD patterns that the SnO₂ nanorods consisted of a tetragonal rutile phase (a=4.755∪, c=3.184∪), which was confirmed by a comparison with standard values (a=4.738∪, c=3.187∪). It may be confirmed that the graphite included a hexagonal phase (a=2.47 Å, c=6.79 Å) and a rhombohedral phase (a=3.635 Å) and remarkable peaks or intensity variation induced due to precipitation of secondary phases or impurities were not generated. It may be appreciated that when the size of the SnO₂ nanorod was increased (that is, in a sequence of S1 to S6), a peak intensity ratio of SnO₂ to the graphite was increased. Since diffraction intensity is in proportion to a weight fraction of a synthetic compound, the result means that a weight fraction of SnO₂ was increased. In addition, a relative intensity of SnO₂ (002) crystal facet was increased in a sequence of S1 to S6. Therefore, it may be appreciated that a growth direction of SnO2 was preferably a <001> direction.

FIGS. 9 and 10 are TEM and HRTEM images of the tin oxide nanorods prepared in the Examples of the present invention.

Referring to FIGS. 9 and 10, a high crystalline property of the SnO₂ nanorod may be confirmed. In addition, a fast Fourier transform pattern confirmed in some of the SnO₂ nanorods exhibits a single crystalline property of the SnO₂ nanorods. A distance (3.35 Å) between neighboring planes corresponds to a distance between two planes (110) of the rutile SnO₂ phase. It may be confirmed that the SnO₂ nanorods were enclosed by (110) crystal facets and a (001) facet was vertical to a nanorod axis. This means that growth of the nanorod was accelerated in the [001] direction.

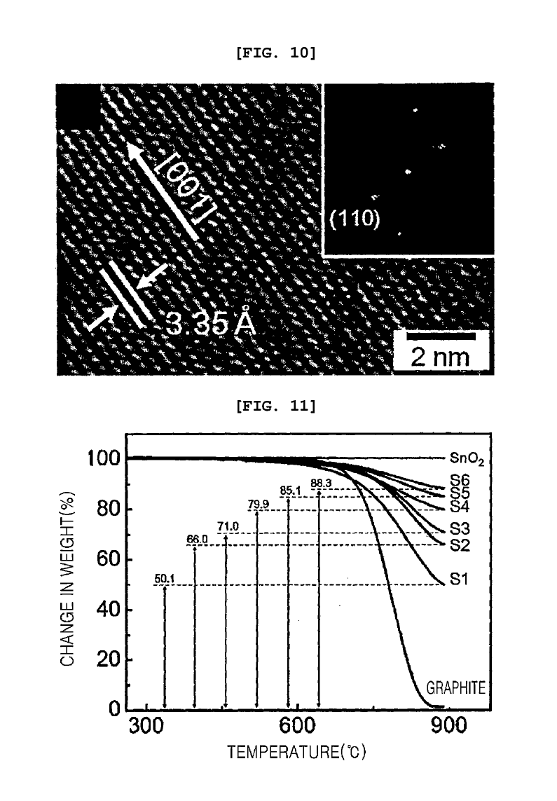

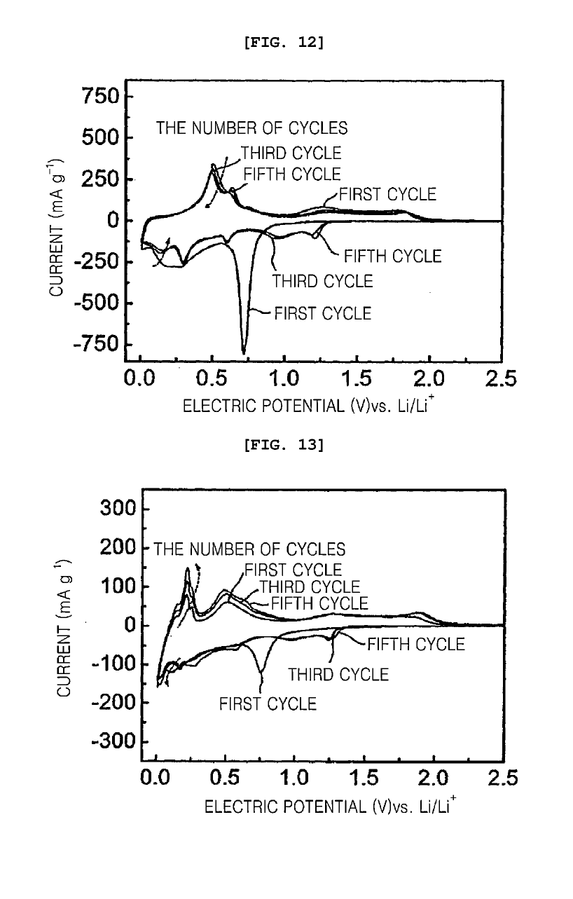

FIG. 11 is a TGA curve of the negative electrode material for a secondary battery prepared in the Example of the present invention. The content (wt. %) of SnO₂ in the graphite on which a plurality of SnO₂ nanorods were grown was quantitatively measured under air atmosphere by TGA, and a temperature was changed from room temperature to 900° C. at a heating rate of 10° C. min⁻¹. In this case, for comparison, SnO₂ and graphite were measured as described above.

Referring to FIG. 11, in the case of SnO₂, a change in weight did not occur at all, and in the case of the graphite, a change in weight occurred by about 98.9% at 600 to 900° C. In addition, it was confirmed that the contents (wt. %) of SnO₂ (that is, S1 to S6) in the graphite on which a plurality of SnO₂ nanorods were grown were 50.1 wt. %, 66.0 wt. %, 71.0 wt. %, 79.9 wt. %, 85.1 wt. %, and 88.3 wt. %, respectively. Therefore, it may be appreciated that the larger the length and diameter of the SnO₂ nanorods, the higher the content of SnO₂.

FIG. 12 is a graph showing a current according to the electric potential of a tin oxide nanowire as a Comparative Example.

FIG. 13 is a graph showing a current versus an electric potential of the negative electrode material for a secondary battery prepared in the Example of the present invention.

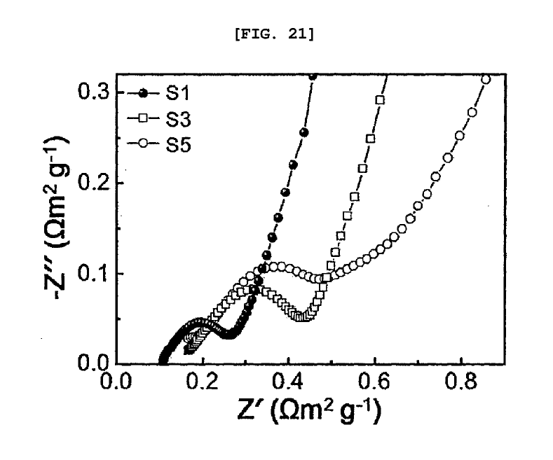

Referring to FIGS. 12 and 21, electrochemical properties of the graphite containing the plurality of SnO₂ nanorods grown thereon were investigated by CVs, galvanostatic charge/discharge and EIS measurements.

CVs of S1 at an electric potential of 2.5 to 0.01V and a scanning rate of 0.05 mVs⁻¹ were shown. CVs behavior indicates electrochemical reactions induced by graphite and SnO₂ during a charge/discharge cycle. The following Reaction Formulas indicate electrochemical reactions of Li⁺ ions with SnO₂ and graphite in the lithium ion battery.

4Li⁺+4e⁻+SnO₂→2Li₂O+Sn (4)

xLi⁺+xe⁻+Sn [symbol] LiₓSn (0≦x≦4.4) (5)

Li++e⁻+C₆ [symbol] LiC₆ (6)

The CV curves indicated formation of a solid electrolyte interface during an initial discharge cycle and a cathodic peak generated at about 0.75V while SnO₂ was reduced into Sn and Li2O (Reaction Formula (4)). In addition, relatively weak peaks were observed at about 0.7 to 0.2V, which relates to formation of LiₓSn (Reaction Formula (5)). Peaks at about 0V were generated by formation of LiC₆ due to insertion of Li into graphite (Reaction Formula (6)).

In an anodic graph, peaks at 0.2 and 0.5V may be generated due to separation of Li from LiC₆ and dealloying of Li from LiₓSn, respectively. As a result, it may be appreciated that, the charge/discharge process of the synthetic compound was a stepwise process. That is, it may be confirmed that first, after Li was alloyed with Sn, Li was inserted into the graphite for a cathodic process, and after Li was firstly separated from LiC₆, the dealloying of the LiₓSn for an anodic reaction was performed.

In addition, it may be confirmed that as the number of cycles was increased, the current density in a CV loop was increased, which means that an activation process may be present during the initial charge/discharge cycle. Since the lithiation/delithiation process generates a structural change of electrically active materials, the activation process may be associated with a reconstruction of internal crystalline structure of the graphite containing the SnO₂ nanorods grown thereon. As a result, activation characteristics were determined by a movement rate of Li⁺ or a formation rate of LiC₆ and Li_{4.4}Sn. Therefore, a movement barrier was gradually activated during each cycle, and the current density was continuously increased until a degradation process of the electrode was superior to the activation process.

Meanwhile, in the case of the SnO₂ nanowire, since a degradation process of the electrode was superior to an activation process, severe performance deterioration may be generated. On the other hand, in the case of the graphite containing the plurality of SnO₂ nanorods grown thereon prepared in Example of the present invention, since the activation process was superior to the degradation process during initial fifth cycles, it may be appreciated that performance degradation was not severe as compared to the SnO₂ nanowire.

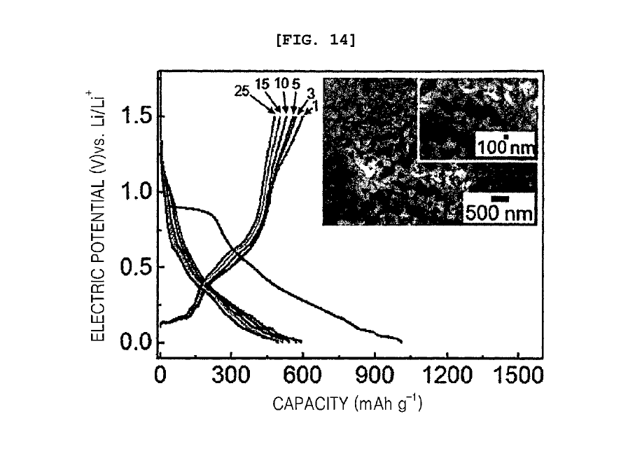

FIG. 14 is a voltage profile of the negative electrode material for a secondary battery prepared in the Example of the present invention.

Referring to FIG. 14, it may be appreciated that the graphite containing the plurality of SnO₂ nanorods grown thereon has significantly high initial discharging capacity of 1010 mAg⁻¹, which was a value between those of SnO₂ and graphite. As described above, high capacity was attributed to the 1-dimensional SnO₂ efficiently moving electrons and providing a wide interface region, which may improve mobility of Li⁺.

Further, stable capacity retention after the initial cycle indicates that electrically active synthetic compounds were uniformly dispersed in an electrode membrane without coagulation. In the graphite electrode containing the plurality of SnO₂ nanorods grown thereon, Li was completely alloyed/dealloyed, and initial Coulombic efficiency (59.2%) higher than theoretical value (52%) for the SnO₂ electrode was obtained.

Therefore, it may be appreciated that the Coulombic efficiency of the graphite electrode containing the plurality of SnO₂ nanorods grown thereon was high as compared to SnO₂ based material of which the Coulombic efficiency was generally 40 to 50%. An initial irreversible capacity loss was mainly generated due to electrolysis of the electrically active materials. Since the graphite suppresses irreversible side reactions as compared to other materials such as Si, Fe₂O₃, Co₃O₄, and the like, the graphite containing the plurality of SnO₂ nanorods grown thereon may have higher Coulombic efficiency.

After the first discharging process, the SEI layers covering the graphite surface on which the plurality of SnO₂ nanorods were grown may prevent the electrolyte from being further decomposed. As a result, the Coulombic efficiency was significantly increased up to 94.2% at the second cycle.

In addition, inserted SEM images shown in FIG. 14 indicate SnO₂ nanorod arrays maintained on the graphite core after the 25^{th} cycle, and it may be confirmed that structural integrity of the nanorod arrays was maintained in spite of a change in volume. Therefore, it may be appreciated that an electric connection loss between the SnO₂ nanorods was decreased.

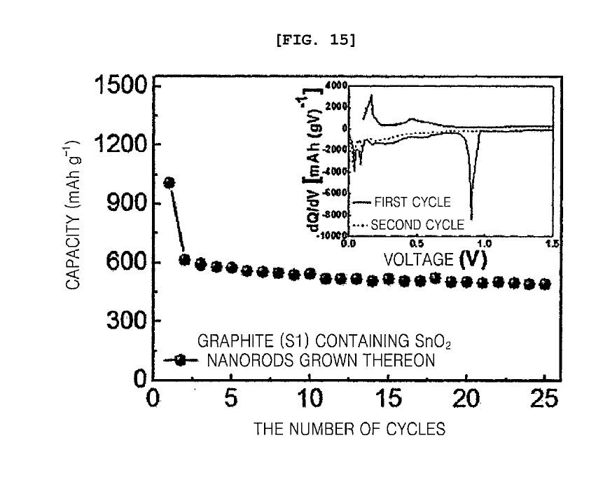

FIG. 15 is a graph showing a capacity versus the number of cycles of the negative electrode material for a secondary battery prepared in the Example of the present invention.

Referring to FIG. 15, it may be confirmed through constant current cycling profile of the graphite (S1) electrode containing the plurality of SnO₂ nanorods grown thereon that cycling performance was improved, and reversible capacity was maintained during 25 cycles.

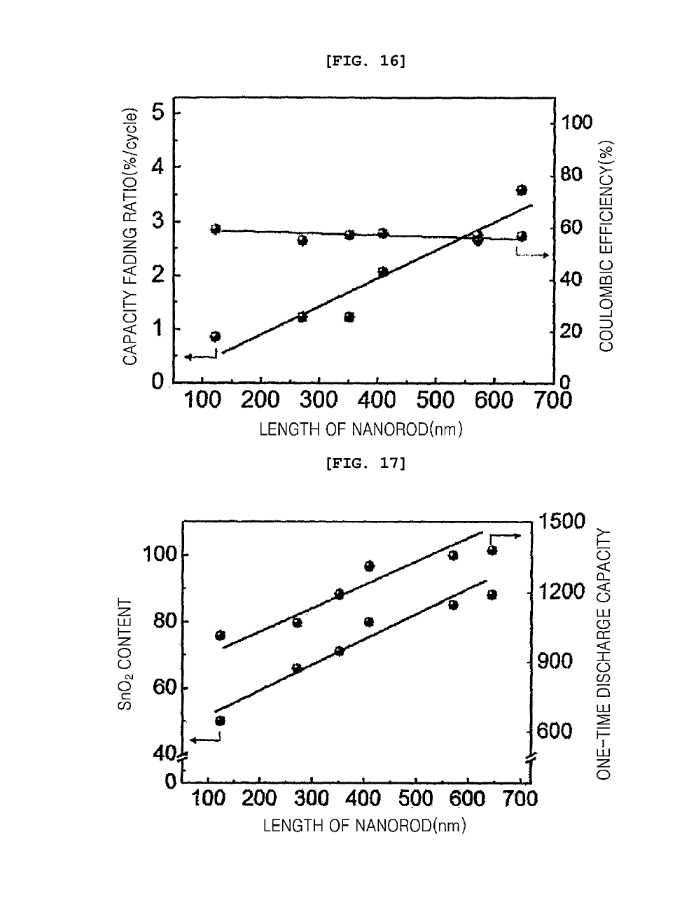

FIG. 16 is a diagram showing a capacity fading ratio and Coulombic efficiency versus the length of the nanorod of the negative electrode material for a secondary battery prepared in the Example of the present invention.

An average capacity fading ratio of the graphite (S1) containing the plurality of SnO₂ nanorods grown thereon was 0.85% at each cycle after a second cycle, and it may be confirmed that capacity retention was excellent. Since elastic force of carbon is larger than that of SnO₂, elastic graphite on which the nanorods are spaced apart from each other may effectively receive strain energy when the SnO₂ nanorods and the graphite are reacted with Li⁺. Therefore, the graphite containing the plurality of SnO₂ nanorods grown thereon has excellent cyclability.

FIG. 17 is a diagram showing a relationship between a tin oxide content and first cycle discharge capacity according to the length of the nanorod of the negative electrode material for a secondary battery prepared in Example of the present invention.

Referring to FIG. 17, as the length of the SnO₂ nanorod was increased, the tin oxide content and the one-time discharge capacity were increased. This means that both of the SnO₂ nanorod and the graphite contribute to the total capacity of the electrode.

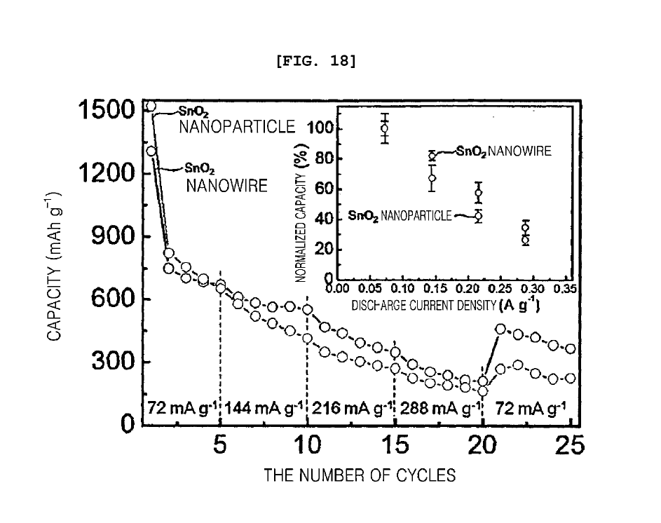

FIG. 18 is a graph showing capacities of the tin oxide nanowires and nanoparticles versus the number of cycles in various current densities as the Comparative Examples.

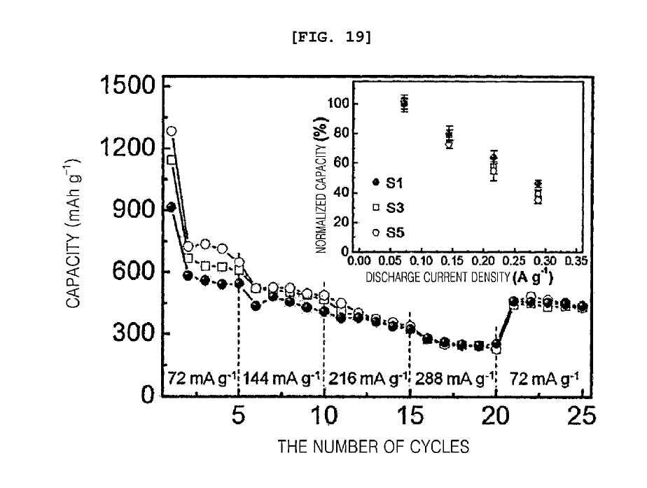

FIG. 19 is a graph showing capacities of a plurality of negative electrode materials for a secondary battery prepared in the Example of the present invention according to the number of cycles in various current densities.

Referring to FIGS. 18 and 19, as a result of investigating rate capability of S1, S3, and S5, in each cell, the current density was increased from 72 mAg⁻¹ to 288 mAg⁻¹ by 72 mAg⁻¹ and then circulated. Therefore, it may be appreciated that in the case of S1, capacity of about 257.7 mAg⁻¹ may still move even at high current density of 288 mAg⁻¹. Further, in the cases of S3 and S5, the delivered capacity was 249.3 mAg⁻¹ and 248.2 mAg⁻¹, respectively. Meanwhile, in the case in which the current density was decreased from 288 mAg⁻¹ to 72 mAg⁻¹, 81.7% of the initial capacity may be recovered again with respect to S1.

In the case in which high-rate capabilities of the SnO₂ nanowire and the SnO₂ nanoparticle were compared under the same test conditions in order to find out a cause of improved performance of the graphite containing the SnO₂ nanorods grown thereon, the synthesized SnO₂ nanowire had a diameter of about 80 nm and a length of a micrometer, and the SnO₂ nanoparticles had a diameter of about 100 nm. The SnO₂ nanowire and the SnO₂ nanoparticle had discharge capacities of 242.5 mAhg⁻¹ and 192.9 mAhg⁻¹ at the current density of 288 mAg⁻¹, respectively, and 58.8% and 34.4% of their capacities were recovered, respectively.

In addition, referring to FIGS. 18 and 19, it may be confirmed that a normalized capacity (81.8%) of the SnO₂ nanowire was higher than a normalized capacity (79.5%) of the graphite (S1) containing the SnO₂ nanorods grown thereon at a low current density of 144 mAg⁻¹, but capacity retention (46.2%) of the graphite (S1) containing the SnO₂ nanorods grown thereon was significantly improved as compared to capacity retention (34.5%) of the SnO₂ nanowire at a high density current of 288 mAg⁻¹. Therefore, as the charge/discharge ratio was increased, the capacity fading rate of the graphite containing the SnO₂ nanorods grown thereon was decreased as compared to that of the SnO₂ nanowire. As a result, it may be appreciated that the graphite (S1, S3, and S5) containing the nanorods grown thereon had more excellent charge/discharge performance, stable capacity retention, and higher recovery capacity ratio as compared to the SnO₂ nanowire and the SnO₂ nanoparticle. Therefore, the 1-dimensional SnO₂ bound to the graphite may improve the high-rate capability of the SnO₂ based electrode.

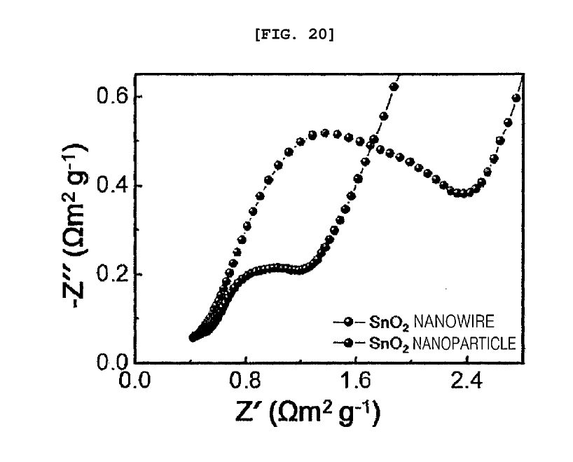

FIG. 20 is a graph showing Nyquist plots of tin oxide nanowires and nanoparticles as the Comparative Examples.

FIG. 21 is a graph Nyquist plots of a plurality of the negative electrode materials for a secondary battery prepared in Example of the present invention.

Referring to FIGS. 20 and 21, Nyquist plots of S1, S3 and S3 were shown. The Nyquist plots consist of linear lines at a low frequency and partially overlapped semi-circles at a high frequency and an intermediate frequency. The semi-circles at the high frequency are associated with resistance R_{SEI} of the SEI layer generated by a passivation reaction of an electrode surface and the electrolyte. The semi-circles at the intermediate frequency correspond to charge transfer resistance R_{ct} generated at the interfaces between the electrically active materials and electrolyte, and the linear lines at the low frequency correspond to Warburg impedance W_{d} due to diffusion of Li⁺ in the electrode material.

It may be confirmed in the Nyquist plots that as the size of the SnO₂ nanorods was increased (that is, in a sequence of S1 to S5), a diameter of the semi-circle was increased. This was associated with a surface region because an amount of the decomposed electrolyte was in proportion to a contact region of the electrolyte. In addition, it may be confirmed that a first semi-circle (R_{SEI}) and a second semi-circle (R_{ct}) of the graphite containing the SnO₂ nanorods grown thereon were significantly smaller as those of the SnO₂ nanowires and nanoparticles. In the case of SnO₂ nanowires and SnO₂ nanoparticles, sums of R_{SEI} and R_{ct} were 2.38 Ωm²g⁻¹ and 1.19 Ωm²g⁻¹, respectively, and in the case of the graphite containing the plurality of SnO₂ nanorods grown thereon, a sum of R_{SEI} and R_{ct} was decreased to 0.26 Ωm²g⁻¹. This indicates that electric conductivity was improved by combination of 1-dimensional SnO₂ nanorods and the graphite. Further, in the case of comparing the Li⁺ movement rate of the graphite containing the plurality of SnO₂ nanorods grown thereon with those of the SnO₂ nanowires and nanoparticles, it may be appreciated that Li⁺ was more rapidly moved due to thinner SEI layers in the graphite. Therefore, the graphite containing the plurality of SnO₂ nanorods grown thereon has improved high-rate capability and cycle stability at a slightly higher current rate as compared to the SnO₂ nanowires and nanoparticles.

The negative electrode material for a secondary battery according to the present invention contains the graphite matrix and the plurality of tin oxide nanorods formed on the graphite matrix, such that the negative electrode material has a larger capacity than that of the graphite and higher Coulombic efficiency and rate capability than those of the SnO₂ based material. The excellent performance as described above may be attributed to the peculiar structure of the negative electrode material. The poor cyclability of the SnO₂ based material is attributed to large change in volume during the charge/discharge process, and accordingly pulverization of electrodes was generated. However, in the negative electrode material for a secondary battery according to the present invention, mechanical stress caused by a rapid change in volume may be decreased due to the vertically grown 1-dimensional SnO₂ nanorods and the elastic graphite, thereby making it possible to decrease degradation of the electrode.

In addition, homogeneous interconnection between electrode membranes are generated due to high affinity between the SnO₂ nanorods and the graphite, such that coagulation or separation of the SnO₂ nanorods during the charge/discharge process may be prevented, thereby making it possible to obtain excellent capacity retention.

Further, the graphite matrix improves conductivity of the electrode, which may improve movement of electrons and decrease a resistance loss. Theoretical Coulombic efficiency of the SnO₂ based materials was 52% due to irreversible formation of Li₂O during the complete Li alloying/dealloying process. However, in the case of the graphite containing the SnO₂ nanorods grown thereon, since the stable SEI is formed on the graphite, the Coulombic efficiency thereof is higher than that of the SnO₂ based materials, which corresponds to an increase in energy density. Therefore, excellent high-rate capability and stable cyclability may be secured.

1. A negative electrode material for a secondary battery comprising:
a graphite matrix; and
a plurality of tin oxide nanorods formed on the graphite matrix.

2. The negative electrode material for a secondary battery of claim 1, wherein the graphite matrix is a plurality of graphite cores.

3. The negative electrode material for a secondary battery of claim 2, wherein the plurality of tin oxide nanorods are square pillars, have a uniform size, and are disposed so as to enclose the graphite core.

4. The negative electrode material for a secondary battery of claim 1, wherein a content of the tin oxide is 50 to 90% by weight based on the total weight of the graphite matrix.

5. The negative electrode material for a secondary battery of claim 1, wherein the plurality of tin oxide nanorods have diameters of 28 to 84 nm, respectively.

6. The negative electrode material for a secondary battery of claim 1, wherein the plurality of tin oxide nanorods have lengths of 123 to 646 nm, respectively.

7. A method for preparing a negative electrode material for a secondary battery, the method comprising:
activating a graphite surface;
coating tin oxide nanoparticles onto the activated graphite surface to prepare a tin oxide seed-type graphite; and
hydrothermally heating the tin oxide seed-type graphite to grow a plurality of tin oxide nanorods.

8. The method of claim 7, wherein in the coating of tin oxide nanoparticles onto the activated graphite surface to prepare a tin oxide seed-type graphite, activated graphite powder is dispersed in a solution in which a hydrate of a material containing tin is contained, and a solution containing hydroxyl ions is added thereto and then stirred to thereby coat the tin oxide nanoparticles onto the graphite surface.

9. The method of claim 8, wherein the hydrate of the material containing tin is tin (II) chloride pentahydrate (SnCl₄.5H₂O), and the solution containing the hydroxyl ions is a sodium hydroxide (NaOH) aqueous solution.

10. The method of claim 9, wherein a molar ratio of sodium hydroxide (NaOH) to tin (II) chloride pentahydrate (SnCl₄.5H₂O) is 1:10.5 to 1:24.
